(19) United States
(12) Patent Application Publication
(10) Pub. No.: US 2016/0004122 A1
(43) Pub. Date: Jan. 7, 2016

(54) LIQUID CRYSTAL DISPLAY DEVICE CONDUCTIVE TAPE ATTACHING STRUCTURE, LIQUID CRYSTAL DISPLAY DEVICE, AND MANUFACTURING METHOD THEREOF

(71) Applicant: NLT TECHNOLOGIES, LTD., Kawasaki (JP)

(72) Inventor: Shin-Ichirou ONO, Kanagawa (JP)

(73) Assignee: NLT TECHNOLOGIES, LTD., Kawasaki (JP)

(21) Appl. No.: 14/792,086

(22) Filed: Jul. 6, 2015

(30) Foreign Application Priority Data
Jul. 4, 2014 (JP) 2014-138798

(51) Int. Cl. G02F 1/1335; G02B 5/30

(52) U.S. Cl. CPC G02F 1/133528; G02B 5/3033

(57) ABSTRACT

To provide a liquid crystal display device conductive tape attaching structure and the like capable of improving the connecting strength without disturbing reduction in the thickness and the size and without disturbing light transmittance. The conductive tape attaching structure of the liquid crystal display device includes: a CF glass substrate where an ITO layer is provided; a polarization plate which is laminated to the CF glass substrate by sandwiching the ITO layer; and a conductive tape having one end which is sandwiched between the CF glass substrate and the polarization plate and connected to the ITO layer.

### CROSS-REFERENCE TO RELATED APPLICATION

This application is based upon and claims the benefit of priority from Japanese patent application No. 2014-138798, filed on Jul. 4, 2014, the disclosure of which is incorporated herein in its entirety by reference.

### BACKGROUND OF THE INVENTION

1. Field of the Invention

The present invention relates to a conductive tape attaching structure and the like of a lateral electric field type liquid crystal display device and an on-cell touch panel liquid crystal display device, for example.

2. Description of the Related Art

A liquid crystal display device referred to as a lateral electric field type is a type which applies an electric field that is to be applied to the liquid crystal in a direction in parallel to the substrate, having an advantage of being able to improve the visual characteristic compared with a TN (Twisted Nematic) type and the like. As the lateral electric field type liquid crystal display device, there are types such as an IPS (In-Plane Switching) type and an FFS (Fringe Field Switching) type.

The lateral electric field type liquid crystal device has a structure in which liquid crystal is sandwiched between a first substrate and a second substrate, and a comb-shaped pixel electrode and a common electrode that generates a lateral electric field between with the pixel electrode are provided on the second substrate. However, with such lateral electric field type liquid crystal device, in a case where an electric charge is charged to the first substrate where no electrode is provided by static electricity or the like, an electric field is generated also between the first substrate and the second substrate. Thus, proper display cannot be provided. Related Techniques 1 to 3 for preventing such electrification will be described.

First, Related Technique 1 will be described. FIG. 9 is a sectional view showing a liquid crystal display device of Related Technique 1.

The liquid crystal display device 110 of Related Technique 1 includes: a CF (Color Filter) glass substrate 111 on which an ITO (Indium Tin Oxide) layer 114 for preventing electrification is provided; a TFT (Thin Film Transistor) glass substrate 112 on which a conductor pattern 115 for grounding is provided; a liquid crystal material 116 inserted between the CF glass substrate 111 and the TFT glass substrate 112; a seal member 116a for sealing the liquid crystal material 116; a conductive tape 117a for connecting the ITO layer 114 to the conductive pattern 115; a polarization plate 118a which is attached to the CF glass substrate 111; a polarization plate 118b which is laminated on the TFT glass substrate 112; an adhesive layer 119a for laminating the polarization plate 118a to the CF glass substrate 111; an adhesive layer 119b for laminating the polarization plate 118b to the TFT glass substrate 112; an FPC (Flexible Printed Circuit) substrate 113 connected to the TFT glass substrate 112; and the like.

One end of the conductive tape 117a is connected to the ITO layer 114 by a conductive paste 117b, and the other end is connected to the conductor pattern 115 by a conductive adhesive contained in the conductive tape 117a. The conductor pattern 115 is connected to a pressure terminal 113a of the FPC substrate 113 and connected to an external GND (ground) via the FPC substrate 113.

Static electricity applied to the CF glass substrate 111 from outside flows from the ITO layer 114 to the conductor pattern 115 on the TFT glass substrate 112 via the conductive tape 117a. The conductor pattern 115 is connected to the external GND via the FPC substrate 113, so that the applied static electricity is discharged to the external GND.

Note that Related Technique 1 is structured by referring to FIG. 1 and FIG. 2 of Japanese Unexamined Patent Publication 2008-145686 (Patent Document 1) to be easily compared to the present invention. For example, in Patent Document 1, the ITO layer 114 and the conductor pattern 115 are directly connected by the conductive paste 117b without using the conductive tape 117a.

Next, Related Technique 2 will be described. FIG. 10 is a sectional view showing a liquid crystal display device of Related Technique 2.

A liquid crystal display device 120 of Related Technique 2 is a technique for improving the connecting strength through connecting a conductive tape 127 and the ITO layer 114 by using thermal pressure contact or thermal melting of the conductive tape 127 in Related Technique 1 (see FIG. 2 of Japanese Unexamined Patent Publication 2008-203590 (Patent Document 2)).

Next, Related Technique 3 will be described. A liquid crystal display device, not shown, of Related Technique 3 is a technique which uses a transparent conductive film constituted with two layers made with a transparent film and a transparent conductive layer instead of the ITO layer of Related Technique 1, laminates the transparent conductive film to the outer surface of a CF glass substrate via an adhesive layer, and extends a part of the transparent conductive film to be connected to a TFT glass substrate (see FIG. 1 of Japanese Unexamined Patent Publication 2010-117458 (Patent Document 3)).

Here, Related Technique 4 regarding an on-cell touch liquid crystal display device will be described. Related Technique 4 is not a technique for preventing electrification. However, it has a structure that is common to Related Techniques 1 to 3. FIG. 11 is a plan view showing a liquid crystal display device of Related Technique 4. Cross section taken along a line X-X in FIG. 11 is almost same as that of FIG. 10. Note, however, that “conductor pattern 115” and “conductive tape 127” in FIG. 10 correspond to “conductor pattern 451” and “conductive tape 471” of Related Technique 4, respectively. Hereinafter, explanations will be provided by referring to FIG. 10 and FIG. 11.

A liquid crystal display device 140 of Related Technique 4 is an example where the structure of the liquid crystal display device of Related Technique 2 is used for an on-cell touch liquid crystal display device. Thus, instead of a part of the liquid crystal display device of Related Technique 2 or in addition to the structure of the liquid crystal display device of Related Technique 2, the liquid crystal display device 140 further includes: four wiring conductor patterns 451 to 454 provided on the TFT glass substrate 112; conductive tapes 471 to 474 for connecting four corners of the ITO layer 114 and the conductor patterns 451 to 454 on one-on-one basis; a liquid crystal driving IC (Integrated Circuit) 116b mounted to the TFT glass substrate 112; a circuit substrate 571 connected to the FPC substrate 113; a touch panel driving IC 572 which is mounted to the circuit substrate 571 and connected to the conductor patterns 451 to 454; and the like. The inner side of the polarization plate 118a is a display area 110a.

More specifically, the liquid crystal display device 140 includes the ITO layer 114 provided on the surface of the CF glass substrate 111 as in the case of a lateral electric field type liquid crystal display device. The difference with respect to the lateral electric field type liquid crystal display device is that same-phase and same-amplitude pulse voltages are inputted to the four corners of the ITO layer 114. One end of each of the conductive tapes 471 to 474 is laminated to the four corners of the ITO layer 114. The other end of each of the conductive tapes 471 to 474 is connected to the wiring conductor patterns 451 to 454 formed on the TFT glass substrate 112, respectively. Each of the conductor patterns 451 to 454 is connected to the touch panel driving IC 572 on the circuit substrate 571 via the FPC substrate 113.

The actions of the liquid crystal display device 140 will be described. First, the touch panel driving IC 572 outputs the same-phase and same-amplification pulse voltages to the conductive tapes 471 to 474 at the four corners through the conductor patterns 451 to 454. Even when the pulse voltages are applied to the ITO layer 114 from the conductive tapes 471 to 474 at the four corners, normally no electric current is flown since those voltages are of same phase and same amplification. It is because there is no potential difference generated between the conductive tapes 471 to 474.

In that state, when the display area 110a is touched by a touch pen 141 (or a finger) or the like, a floating capacitance for GND is generated. Thus, electric currents I1 to I4 are generated, respectively, from the conductive tapes 471 to 474 at the four corners. The touch panel driving IC 572 detects the electric current values at the four corners, and calculates and outputs the position coordinates from those values. Thereby, the liquid crystal display device 140 functions as a touch panel.

However, there are following issues to be overcome in Related Techniques 1 to 4.

In the liquid crystal display device 110 of Related Technique 1 shown in FIG. 9, the ITO layer 114 and the conductor pattern 115 are connected by using the conductive paste 117b or the like. However, it is difficult to control the thickness of the conductive paste 117b. The conductive paste 117b is applied on the CF glass substrate 111. Thus, when the thickness of the conductive paste 117b exceeds the height of the polarization plate 118a, variation in the total thickness 110t of the liquid crystal display device 110 is increased and reduction in the thickness of the liquid crystal display device 110 is obstructed. Further, in a case where only the conductive tape 117a is used without using the conductive paste 117b, the conductivity of the conductive tape 117a is secured by mixing conductive particles or the like inside the adhesive thereof. Thus, the adhesive force thereof is weaker than the regular adhesive tape, so that it is easily exfoliated by an external force, heat, or the like.

In the liquid crystal display device 120 of Related Technique 2 shown in FIG. 10, the conductive tape 127 is connected to the ITO layer 114 by thermal compression or thermal dissolution as a measure for preventing the conductive tape from being easily exfoliated. However, the polarization plate 118a and other materials are heated and changed in the quality, thereby deteriorating the image quality. Further, in a case where a pressure is applied to the conductive tape 127, the gap between the CF glass substrate 111 and the TFT glass substrate 112 is changed partially, thereby generating display unevenness.

Further, it is required to provide a pasting space 120s for pasting the conductive tape 127 by thermal pressure or thermal melting. In a case where the conductive tape is not laminated, it is sufficient to have about 0.3 to 0.5 mm for the distance from the end of the polarization plate 118a to the end of the CF glass substrate 111. However, in a case where the conductive tape 127 is pasted by hands as in Patent Document 1 or in a case where the conductive tape is pasted by thermal pressure as in Patent Document 2, the laminating space 120s of some extent (about 2 mm) is required. Therefore, such space becomes an obstruction for reducing the size of the liquid crystal display device 120.

In the liquid crystal display device of Related Technique 3, a transparent conductive film is provided on the CF glass substrate via an adhesive layer. Thus, compared to a case where the ITO layer is directly sputtered on the CF glass substrate, the transparent film and the adhesive layer are provided additionally. Thus, brightness of the liquid crystal display device is deteriorated. For example, assuming that transmittance of a transparent film is 90% and transmittance of an adhesive layer is 90%, transmittance of the transparent film and the adhesive layer becomes about 80%. Thus, the luminance is decreased by 20% compared to a case where the transparent film and the adhesive film are not used.

In the liquid crystal display device 140 of Related Technique 4 shown in FIG. 11, the conductive tapes 471 to 474 are pasted to the four corners of the ITO layer 114. Thus, the area of the CF glass substrate 111 is expanded to provide the pasting space 120s as in the case of Related Technique 2. Those pasting spaces 120s are the obstructions for decreasing the size of the liquid crystal display device 140.

It is therefore an exemplary object of the present invention to provide a conductive tape attaching structure and the like of a liquid crystal display device capable of improving the connecting strength without obstructing reduction in the thickness and the size and without obstructing the light transmittance of the liquid crystal display device.

### SUMMARY OF THE INVENTION

A liquid crystal display device conductive tape attaching structure according to an exemplary aspect of the invention includes: a substrate where a transparent conductive layer is provided; a polarization plate laminated to the substrate by sandwiching the transparent conductive layer; and a conductive tape having one end which is sandwiched between the substrate and the polarization plate and connected to the transparent conductive layer.

A manufacturing method of the liquid crystal display device conductive tape attaching structure according to another exemplary aspect of the invention is a method for manufacturing a conductive tape attaching structure of a liquid crystal display device which includes: a substrate where a transparent conductive layer is provided; a polarization plate laminated to the substrate by sandwiching the transparent conductive layer; and a conductive tape having one end which is sandwiched between the substrate and the polarization plate and connected to the transparent conductive layer, and the method includes: overlapping one end of the conductive tape with the transparent conductive layer, and laminating the polarization plate thereon to connect the conductive tape to the transparent conductive layer

A liquid crystal display device according to still another exemplary aspect of the invention includes: a first substrate which includes a first face and a second face in a front and back relation, and includes an anti-electrification transparent conductive layer provided on the first face; a second substrate which includes a first face and a second face in a front and back relation, and includes a grounding conductor pattern provided on the first face; a liquid crystal material sealed between the second face of the first substrate and the first face of the second substrate; a conductive tape which connects the transparent conductive layer and the conductor pattern; a first polarization plate which is laminated to the first face of the first substrate by sandwiching the transparent conductive layer; and a second polarization plate which is laminated to the second face of the second substrate, wherein one end of the conductive tape is sandwiched between the first substrate and the first polarization plate and connected to the transparent conductive layer.

A manufacturing method of a liquid crystal display device according to still another exemplary aspect of the invention is a method for manufacturing a liquid crystal display device which includes: a first substrate which includes a first face and a second face in a front and back relation, and includes an anti-electrification transparent conductive layer provided on the first face; a second substrate which includes a first face and a second face in a front and back relation, and includes a grounding conductor pattern provided on the first face; a liquid crystal material sealed between the second face of the first substrate and the first face of the second substrate; a conductive tape which connects the transparent conductive layer and the conductor pattern; a first polarization plate which is laminated to the first face of the first substrate by sandwiching the transparent conductive layer; and a second polarization plate which is laminated to the second face of the second substrate, and the method includes: overlapping one end of the conductive tape with the transparent conductive layer, and laminating the polarization plate thereon to connect the conductive tape to the transparent conductive layer.

As an exemplary advantage according to the invention, the present invention makes it possible to improve the connecting strength of the conductive tape of the liquid crystal display device without disturbing reduction in the thickness, and the size and without disturbing light transmittance through connecting the conductive tape and the transparent conductive layer by sandwiching the conductive tape between the substrate where the transparent conductive layer is provided and the polarization plate.

### BRIEF DESCRIPTION OF THE DRAWINGS

FIG. 1 is a plan view showing a liquid crystal display device according to a first exemplary embodiment;

FIG. 2 is a sectional view taken along a line II-II of FIG. 1;

FIG. 3 is a sectional view showing a liquid crystal display device according to a second exemplary embodiment;

FIG. 4 is a sectional view showing a liquid crystal display device according to a third exemplary embodiment;

FIG. 5 is a sectional view showing a liquid crystal display device according to a fourth exemplary embodiment;

FIG. 6 is a sectional view showing a liquid crystal display device according to a fifth exemplary embodiment;

FIG. 7 is a sectional view showing a liquid crystal display device according to a sixth exemplary embodiment;

FIG. 8 is a plan view showing a liquid crystal display device according to a seventh exemplary embodiment;

FIG. 9 is a sectional view showing a liquid crystal display device according to Related Technique 1;

FIG. 10 is a sectional view showing a liquid crystal display device according to Related Technique 2; and

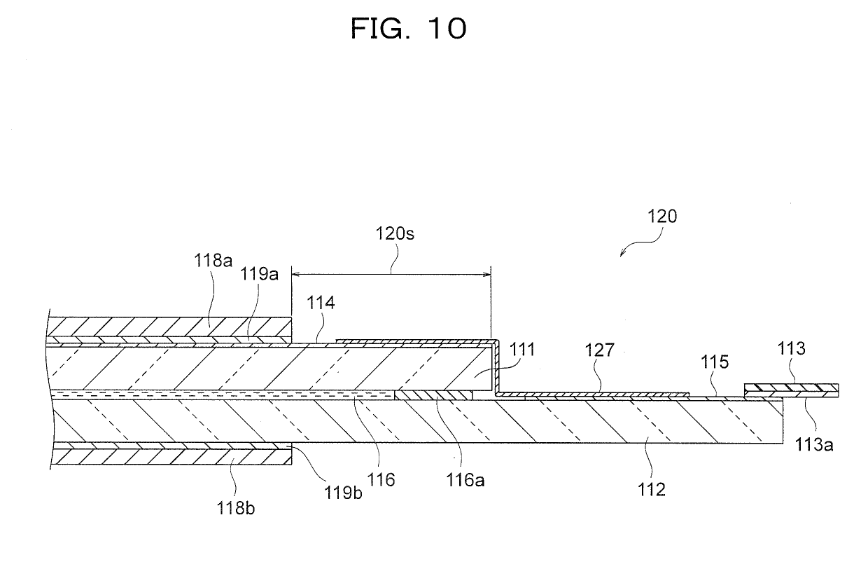

FIG. 11 is a plan view showing a liquid crystal display device according to Related Technique 4.

### DETAILED DESCRIPTION OF THE PREFERRED EMBODIMENTS

Hereinafter, modes (referred to as “exemplary embodiments” hereinafter) for embodying the present invention will be described by referring to the accompanying drawings. The liquid crystal display device according to the present invention includes a conductive tape attaching structure of the liquid crystal display device, so that the exemplary embodiment of the conductive tape attaching structure of the liquid crystal display device according to the present invention can be described through describing the exemplary embodiment of the liquid crystal display device according to the present invention. Same reference numerals are used for substantially same structural elements in the current Specification and the drawings. The shapes in the drawings are drawn to be easily comprehended by those skilled in the art, so that sizes and ratios thereof are not necessarily consistent with the actual ones.

### First Exemplary Embodiment

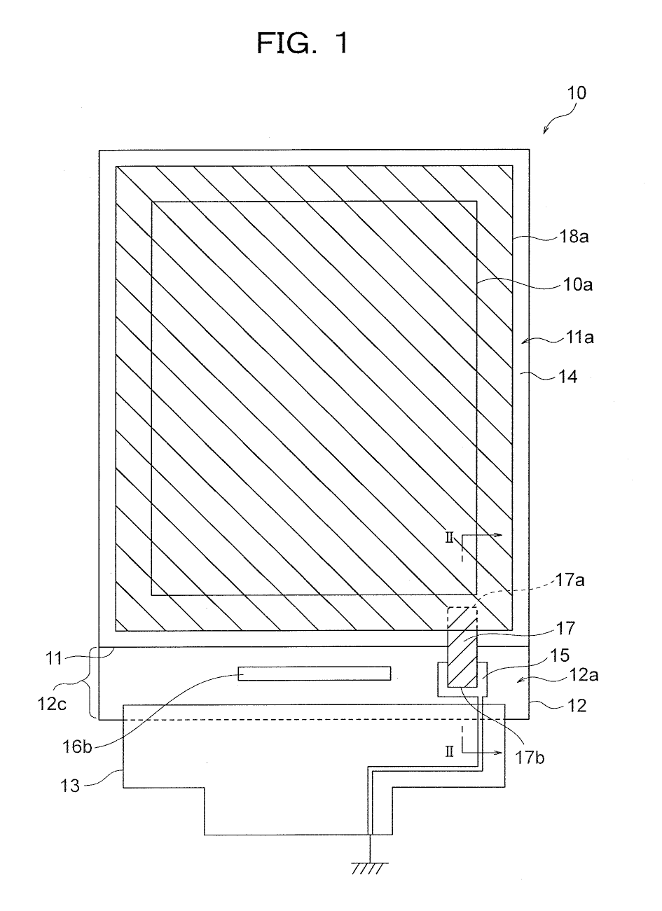

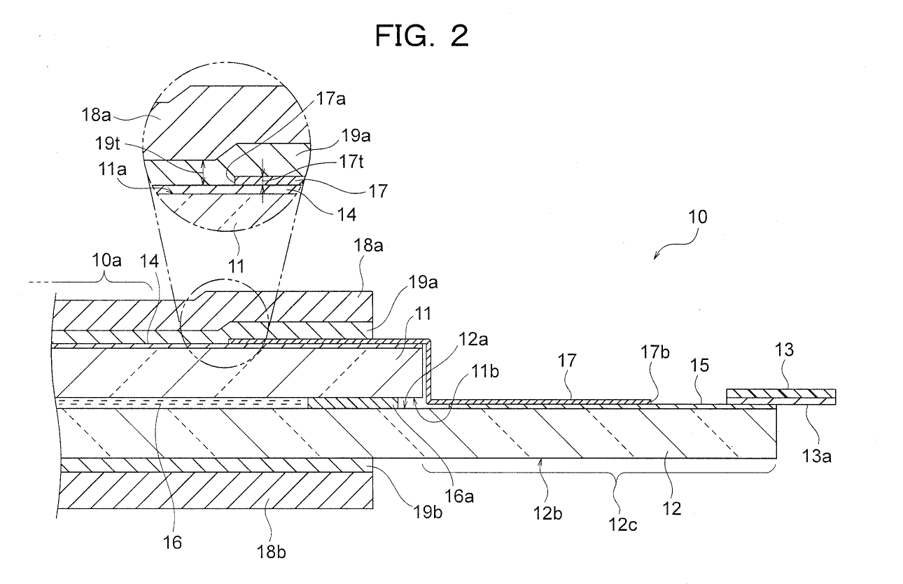

FIG. 1 is a plan view showing a liquid crystal display device according to a first exemplary embodiment. FIG. 2 is a sectional view taken along a line II-II of FIG. 1. In FIG. 1, oblique lines are applied to the surfaces of a polarization plate 18a and a conductive tape 17 for clarity. In FIG. 2, a part of the drawing is surrounded by a circle with an alternate short and long dash line and shown as an enlarged view. Hereinafter, explanations will be provided by referring to FIG. 1 and FIG. 2.

A CF glass substrate 11, an ITO layer 14, and a polarization plate 18a of the first exemplary embodiment are examples of “substrate”, “transparent conductive layer”, and “polarization plate” in a conductive tape attaching structure of a liquid crystal display device in the scope of the appended claims, respectively. The CF glass substrate 11, a TFT glass substrate 12, an FPC substrate 13, the ITO layer 14, the polarization plate 18a, and a polarization plate 18b of the first exemplary embodiment are examples of “first substrate”, “second substrate”, “third substrate”, “transparent conductive layer”, “first polarization plate”, and “second polarization plate” of the liquid crystal display device in the scope of the appended claims, respectively.

A liquid crystal display device 10 according to the first exemplary embodiment includes: the CF glass substrate 11 which includes a first face 11a and a second face 11b in a front and back relation and includes the anti-electrification ITO layer 14 provided on the first face 11a; the TFT glass substrate 12 which includes a first face 12a and a second face 12b in a front and back relation and includes a grounding conductor pattern 15 provided on the first face 12a; a liquid crystal material 16 sandwiched between the second face 11b of the CF glass substrate 11 and the first face 12a of the TFT glass substrate 12; a conductive tape 17 which connects the ITO layer 14 and the conductor pattern 15; the polarization plate 18a which is laminated to the first face 11a of the CF glass substrate 11 by sandwiching the ITO layer 14 therebetween; and the polarization plate 18b which is laminated to the second face 12b of the TFT glass substrate 12. Further, the conductive tape 17 is fixed to the CF glass substrate 11 and connected to the ITO layer 14 by being sandwiched between the CF glass substrate 11 and the polarization plate 18a.

A manufacturing method of the liquid crystal display device 10 according to the first exemplary embodiment includes a step which fixes the conductive tape 17 to the CF glass substrate 11 and connects to the ITO layer 14 by overlapping the conductive tape 17 on the ITO layer 14 and laminating the polarization plate 18a thereon.

The conductive tape attaching structure of the liquid crystal display device 10 includes: the CF glass substrate 11 on which the ITO layer 14 is provided; the polarization plate 18a which is laminated on the CF glass substrate 11 with the ITO layer 14 sandwiched therebetween; and the conductive tape 17 including one end 17a which is sandwiched between the CF glass substrate 11 and the polarization plate 18a and connected to the ITO layer 14. The conductive tape 17 also includes other end 17b that is grounded. Further, the conductive tape attaching structure of the liquid crystal display device 10 is manufactured by the step which connects the conductive tape 17 to the ITO layer 14 by overlapping the conductive layer 17 on the ITO layer 14 and laminating the polarization plate 18a thereon.

There are a case where the conductor pattern 15 is provided on the first face 12a and a case where the conductor pattern 15 is provided on the first face 12a via a substrate or the like regarding the TFT glass substrate 12 where the grounding conductor pattern 15 is provided on the first face 12a.

The liquid crystal display device 10 further includes an adhesive layer 19a which laminates the polarization plate 18a to the CF glass substrate 11. The thickness 17t of the conductive tape 17 is thinner than the thickness 19t of the adhesive layer 19.

The liquid crystal display device 10 further includes: an adhesive layer 19b which laminates the polarization plate 18b to the TFT glass substrate 12; an FPC substrate 13 connected to the first face 12a of the TFT glass substrate 12; a seal member 16a which seals the liquid crystal material 16 between the CF glass substrate 11 and the TFT glass substrate 12; and the like. The inner side of the polarization plate 18a is a display area 10a.

The overlapping CF glass substrate 11 and TFT glass substrate 12 are both in a rectangular shape, and one side of the TFT glass substrate 12 is an input terminal section 12c that is protruded from the CF glass substrate 11. The conductive tape 17, the FPC substrate 13, a liquid crystal driving IC 16b, and the like are mounted to the input terminal section 12c. The wiring of the liquid crystal driving IC 16b is omitted in the drawings.

Next, the liquid crystal display device 10 of the first exemplary embodiment will be described in more details.

The conductive tape 17 may be any tape-like member as long as it exhibits conductivity. For example, a double-layer film acquired by applying a conductive adhesive on one face of a synthetic resin base material, a double-layer film acquired by forming a metal thin film on one face of a synthetic resin base material, FPC, a metallic foil, a leading wire, or the like may be used, and whether or not it exhibits flexibility and adhesiveness is not an issue. A “tape-like member” herein means any shapes with thickness of 0.5 mm or less, for example, and a rectangular shape, a square shape, a strip shape, string shape, a linear shape, etc., are included.

As shown in FIG. 1 and FIG. 2, one end 17a of the conductive tape 17 is laminated by a conductive adhesive contained in the conductive tape 17 to the anti-electrification ITO layer 14 which is provided to the CF glass substrate 11. The conductive tape 17 is laminated to an outside part of the display area 10a, and the polarization plate 18a is laminated on the conductive tape 17 in an overlapping manner.

The position for laminating the conductive tape 17 is desirable to be set as a position sufficiently distant from the left and right side of the polarization plate 18a that is in parallel to a II-II line of FIG. 1. Thereby, the effect of pressing the conductive tape 17 by the polarization plate 18a is stabilized.

When the thickness 17t of the conductive tape 17 is thick, air bubbles are easily generated between the polarization plate 18a and the CF glass substrate 11 in the periphery of the conductive tape 17. Therefore, it is desirable to use the conductive tape 17 with the thickness 17t that is thinner than the thickness 19t of the adhesive layer 19a.

The thickness 19t of the typical adhesive layer 19a is 0.03 mm to 0.04 mm. For example, when the conductive tape 17 with the thickness 17t of 0.01 to 0.02 mm is used, the conductive tape 17 is buried in the thickness 19t of the adhesive layer 19a so that air bubbles are not easily generated. Further, through thickening the thickness 19t of the adhesive layer 19a and decreasing the viscosity of the adhesive layer 19a, the adhesive layer 19a becomes easily flown in the surroundings of the conductive tape 17. Thus, generation of air bubbles can be decreased further. Through eliminating the conductive adhesive contained in the conductive tape 17 in the part where the polarization plate 18a and the conductive tape 17 overlap with each other, the thickness of the conductive tape 17 can be decreased further.

The other end 17b of the conductive tape 17 is laminated to the grounding conductor pattern 15 of the TFT glass substrate 12 by the conductive adhesive contained in the conductive tape 17. The grounding conductor pattern 15 is connected to a pressure terminal 13a of the FPC substrate 13 and connected to an external GND via the FPC substrate 13.

Next, discharging actions of the liquid crystal display device 10 will be described. Static electricity applied to the CF glass substrate 11 from outside flows to the grounding conductor pattern 15 on the glass substrate 12 from the ITO layer 14 via the conductive tape 17. The conductor pattern 15 is connected to the external GND via the FPC substrate 13, so that the applied static electricity is discharged to the external GND.

Next, effects of the liquid crystal display device 10 will be described. With the first exemplary embodiment, through connecting the conductive tape 17 and the ITO layer 14 by sandwiching the conductive tape 17 between the CF glass substrate where the ITO layer 14 is provided and the polarization plate 18a, connecting strength of the conductive tape 17 can be improved without disturbing reduction in the thickness and the size and without disturbing light transmittance.

The effects of the liquid crystal display device 10 will be described in more details further.

The liquid crystal display device 10 can be preferably used for the types such as lateral electric field types (IPS type, FFS type, and the like) with which the CF glass substrate 11 is easily electrified. The static electricity applied to the CF glass substrate 11 from outside flows to the grounding conductor pattern 15 on the TFT glass substrate 12 from the ITO layer 14 via the conductive tape 17. The conductor pattern 15 is connected to the external GND via the FPC substrate 13. Thus, through discharging the applied static electricity to the external GND, electrification of the CF glass substrate 11 by the external static electricity can be prevented. The conductive tape 17 on the CF glass substrate 11 is reinforced through laminating the polarization plate 18a in an overlapped manner, so exfoliation due to external force or heat is not easily generated.

It is desirable to set the position for laminating the conductive tape 17 to be a position sufficiently distant from the left and right ends of the polarization plate 18a that is in parallel to the II-II line of FIG. 1 since the effect of pressing the conductive tape 17 by the polarization plate 18a can be stabilized.

With Related Techniques 1 and 2, the conductive tape is laminated on the outer side of the end part of the polarization plate so that it is necessary to provide a laminating space, which results in increasing the size. On the contrary, with the first exemplary embodiment, the polarization plate 18a and the conductive tape 17 are laminated in an overlapping manner. Thus, the outermost shape size can be reduced compared to the cases of Related Techniques 1 and 2, so that reduction in the size of the liquid crystal display device 10 is not obstructed.

The polarization plate 18a is used to press the conductive tape 17, so that no exclusive member for reinforcing the conductive tape 17 is used. Thus, no extra cost is required.

With Related Technique 1, connection between the ITO layer and the conductive tape is reinforced by using a conductive paste. Thus, variation in the heap of the conductive tape is great, so that variation in the total thickness of the liquid crystal display device becomes also great. In the meantime, with the first exemplary embodiment, connection of the conductive tape 17 can be reinforced while keeping the variation in the total thickness of the liquid crystal display device 10 small.

### Second Exemplary Embodiment

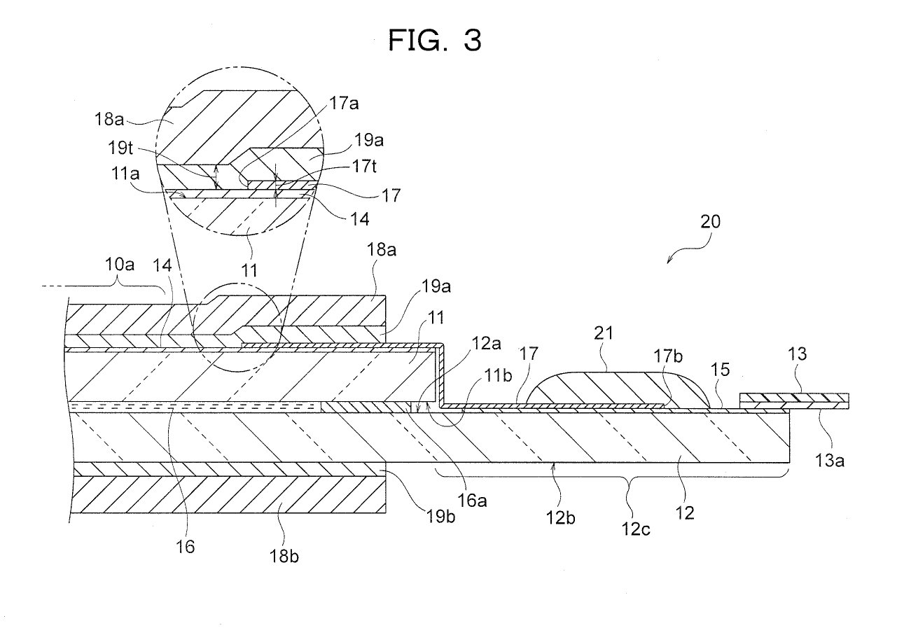

FIG. 3 is a sectional view showing a liquid crystal display device according to a second exemplary embodiment. In FIG. 3, shown are the sections that are different from those of the first exemplary embodiment and surroundings thereof. FIG. 3 corresponds to the sectional view taken along the line II-II of FIG. 1. Hereinafter, explanations will be provided by referring to FIG. 3.

In a liquid crystal display device 20 of the second exemplary embodiment, a resin 21 is applied on the other end 17b side of the conductive tape 17. That is, the conductive tape 17 is fixed to the TFT glass substrate 12 by the resin 21 applied from the above the conductive tape 17, and connected to the conductor pattern 15 by the conductive adhesive contained in the conductive tape 17.

As shown in FIG. 3, one end 17a side of the conductive tape 17 is fixed by overlapping and laminating the polarization plate 18a, and the other end 17b side of the conductive tape 17 is laminated to the conductor pattern 15 and electrically connected thereto in a physical manner. Thereafter, the resin 21 is applied from the above the other end 17b side.

With the second exemplary embodiment, the other end 17b side of the conductive tape 17 is fixed by the resin 21. Thus, the connecting reliability of the conductive tape 17 is improved further. The first face 12a of the TFT glass substrate 12 where the conductor pattern 15 is formed is lower than the surface of the polarization plate 18a on the CF glass substrate 11 by the thickness of the polarization plate 18a, the adhesive layer 19a, and the CF glass substrate 11. Thus, through reducing the applied thickness of the resin 21 to fall within the height difference, the variation in the applied thickness of the resin 21 is absorbed. Therefore, the connecting reliability of the conductive tape 17 can be improved without increasing the variation in the thickness of the entire liquid crystal display device 20. Other structures, operations, and effects of the second exemplary embodiment are same as those of the first exemplary embodiment.

### Third Exemplary Embodiment

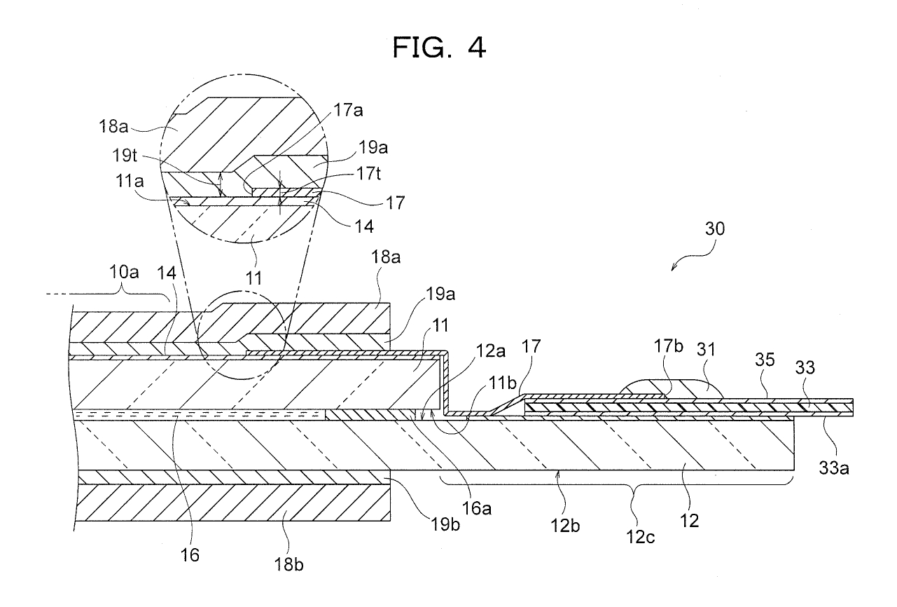

FIG. 4 is a sectional view showing a liquid crystal display device according to a third exemplary embodiment. In FIG. 4, shown are the sections that are different from those of the first exemplary embodiment and surroundings thereof. FIG. 4 corresponds to the sectional view taken along the line II-II of FIG. 1. Hereinafter, explanations will be provided by referring to FIG. 4.

An FPC substrate 33 of the third exemplary embodiment is an example of “third substrate” in the liquid crystal display device in the scope of the appended claims.

A liquid crystal display device 30 of the third exemplary embodiment further includes the FPC substrate 33 which includes a conductor pattern 35 and is provided on the TFT glass substrate 12. The conductive tape 17 is fixed to the FPC substrate 33 by soldering and connected to the conductor pattern 35 by a conductive adhesive contained in the conductive tape 17. That is, the other end 17b of the conductive tape 17 is covered by the solder 31.

As shown in FIG. 4, one end 17a side of the conductive tape 17 is fixed by overlapping and laminating the polarization plate 18a. The grounding conductor pattern 35 is provided on the FPC substrate 33, and the other end 17b side of the conductive tape 17 and the conductor pattern 35 are soldered. The FPC substrate 33 is fixed on the TFT glass substrate 12 by a pressure terminal 33a.

With the third exemplary embodiment, the other end 17b side of the conductive tape 17 is fixed to the FPC substrate 33 by the solder 31. Thus, the connecting reliability of the conductive tape 17 is improved further. The face where the conductor pattern 35 is formed is lower than the surface of the polarization plate 18a on the CF glass substrate 11 by the amount almost the same as the thickness of the polarization plate 18a, the adhesive layer 19a, and the CF glass substrate 11. Thus, through reducing the thickness of the solder 31 to fall within the height difference, the variation in the thickness of the solder 31 is absorbed. Therefore, the connecting reliability of the conductive tape 17 can be improved without increasing the variation in the thickness of the entire liquid crystal display device 30. Other structures, operations, and effects of the third exemplary embodiment are same as those of the first exemplary embodiment.

### Fourth Exemplary Embodiment

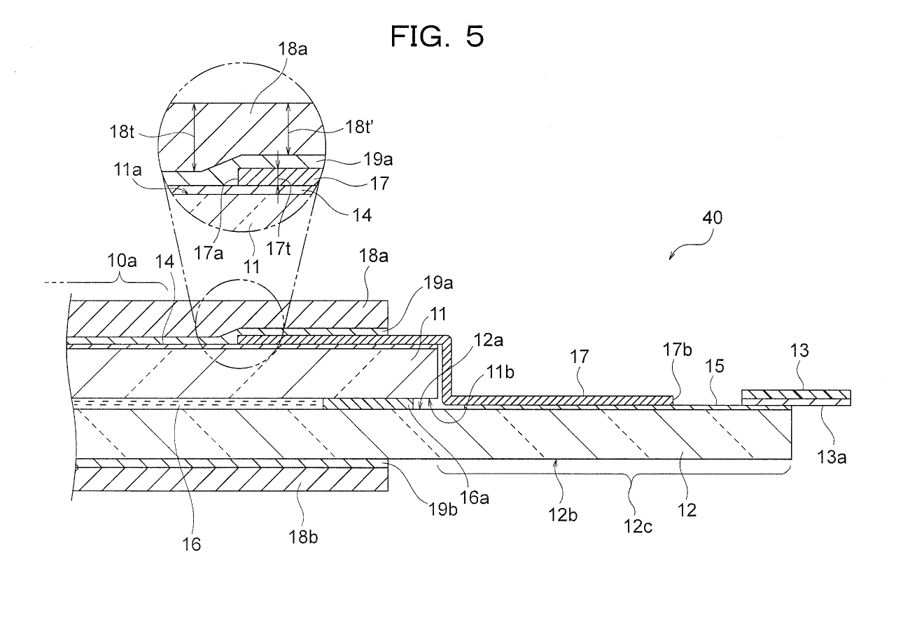

FIG. 5 is a sectional view showing a liquid crystal display device according to a fourth exemplary embodiment. In FIG. 5, shown are the sections that are different from those of the first exemplary embodiment and surroundings thereof. FIG. 5 corresponds to the sectional view taken along the line II-II of FIG. 1. Hereinafter, explanations will be provided by referring to FIG. 5.

A liquid crystal display device 40 of the fourth exemplary embodiment has following features. Regarding the thickness of the polarization plate 18a, the part where the polarization plate 18a overlaps with the conductive tape 17 is thinner than the part where the polarization plate 18a does not overlap with the conductive tape 17 substantially by the thickness of the conductive tape 17. Provided that the thickness 18t of the polarization plate 18 in the part where the polarization plate 18a does not overlap with the conductive tape 17 is “a”, the thickness 18t′ of the polarization plate 18a in the part where the polarization plate 18a overlaps with the conductive tape 17 is “b”, and the thickness 17t of the conductive tape 17 is “c”, “a−b≈c” applies.

As shown in FIG. 5, one end 17a side of the conductive tape 17 is in a structure which is fixed by overlapping and laminating the polarization plate 18a. The thickness 18t′ of the polarization plate 18a in the part where the polarization plate 18a overlaps with the conductive tape is thinner by the thickness 17t of the conductive tape 17. For thinning a part of the polarization plate 18a, a pressure may be applied to the part of which the thickness is desired to be reduced, for example.

In the fourth exemplary embodiment, the thickness 18t′ of the polarization plate 18a in the part where the conductive tape 17 overlaps with the polarization plate 18a is thinner by the thickness 17t of the conductive tape 17. Thus, there is no rise part generated by the thickness 17t of the conductive tape 17 in the part where the conductive tape 17 and the polarization plate 18a overlap with each other. Thus, with the liquid crystal display device 40, it is possible to reduce the thickness of the device. Further, the surface of the polarization plate 18a has no local rise part and can be formed flat, so that the outward appearance can be improved. Other structures, operations, and effects of the fourth exemplary embodiment are same as those of the first exemplary embodiment.

### Fifth Exemplary Embodiment

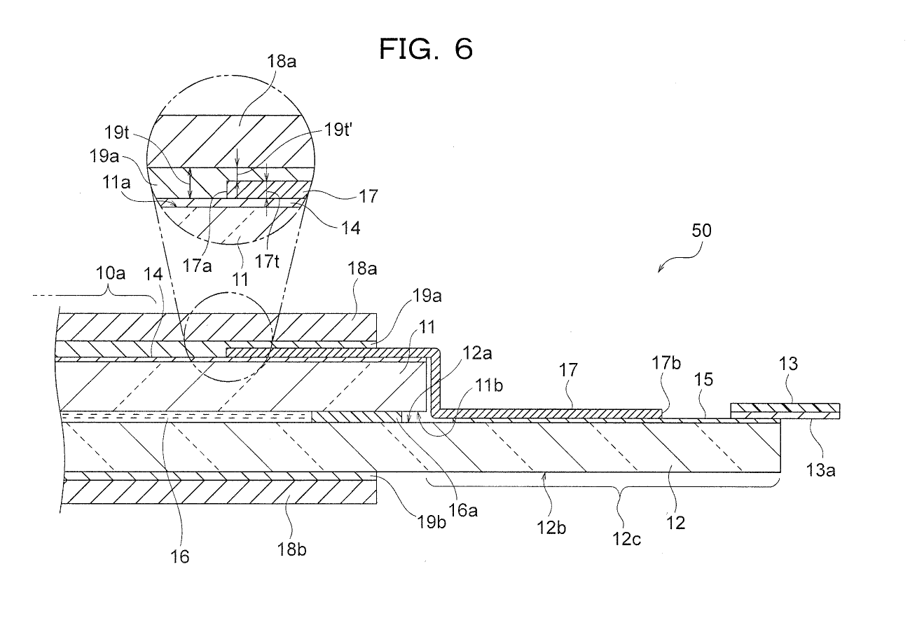

FIG. 6 is a sectional view showing a liquid crystal display device according to a fifth exemplary embodiment. In FIG. 6, shown are the sections that are different from those of the first exemplary embodiment and surroundings thereof. FIG. 6 corresponds to the sectional view taken along the line II-II of FIG. 1. Hereinafter, explanations will be provided by referring to FIG. 6.

A liquid crystal display device 50 of the fifth exemplary embodiment has following features. Regarding the thickness of an adhesive layer 19a, the part where the polarization plate 18a overlaps with the conductive tape 17 is thinner than the part where the polarization plate 18a does not overlap with the conductive tape 17 substantially by the thickness of the conductive tape 17. Provided that the thickness 19t of the adhesive layer 19a in the part where the polarization plate 18a does not overlap with the conductive tape 17 is “a”, the thickness 19t′ of the adhesive layer 19a in the part where the polarization plate 18a overlaps with the conductive tape 17 is “b”, and the thickness 17t of the conductive tape 17 is “c”, “a−b≈c” applies.

As shown in FIG. 6, one end 17a side of the conductive tape 17 is in a structure which is fixed by overlapping and laminating the polarization plate 18a. The thickness 19t′ of the adhesive layer 19a in the part where the polarization plate 18a and the conductive tape overlap with each other is thinner by the thickness 17t of the conductive tape 17. For thinning a part of the adhesive layer 19a, first, an adhesive is slightly applied entirely and then the adhesive is applied partially, for example.

In the fifth exemplary embodiment, the thickness 19t′ of the adhesive layer 19a in the part where the conductive tape 17 overlaps with the polarization plate 18a is thinner by the thickness 17t of the conductive tape 17. Thus, there is no rise part generated by the thickness 17t of the conductive tape 17 in the part where the conductive tape 17 overlaps with the polarization plate 18a. Thus, with the liquid crystal display device 50, it is possible to reduce the thickness of the device. Further, the surface of the polarization plate 18a has no local rise part and can be formed flat, so that the outward appearance can be improved. Other structures, operations, and effects of the fifth exemplary embodiment are same as those of the first exemplary embodiment.

### Sixth Exemplary Embodiment

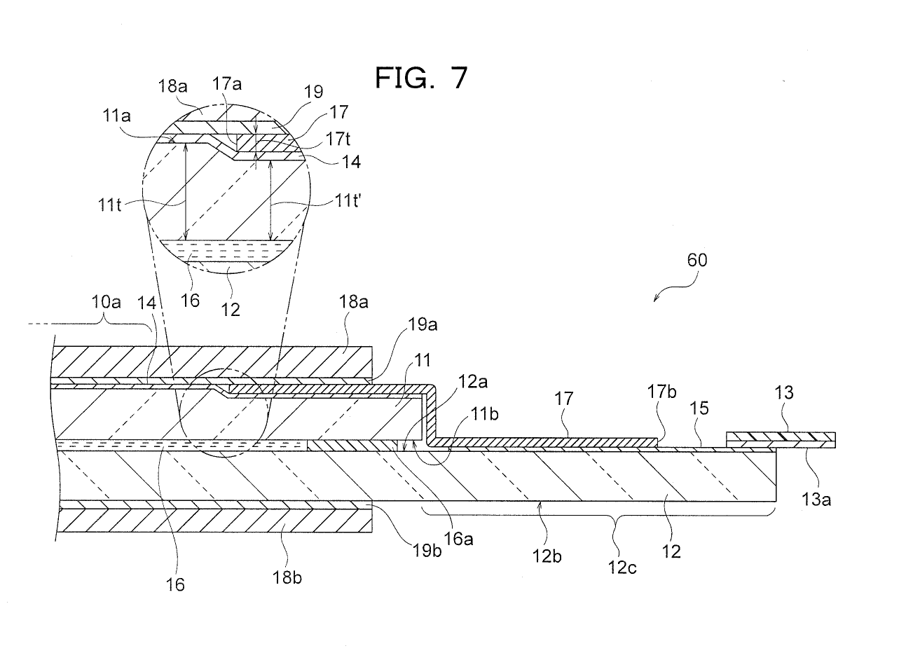

FIG. 7 is a sectional view showing a liquid crystal display device according to a sixth exemplary embodiment. In FIG. 7, shown are the sections that are different from those of the first exemplary embodiment and surroundings thereof. FIG. 7 corresponds to the sectional view taken along the line II-II of FIG. 1. Hereinafter, explanations will be provided by referring to FIG. 7.

A liquid crystal display device 60 of the sixth exemplary embodiment has following features. Regarding the thickness of the CF glass substrate 11, the part where the polarization plate 18a overlaps with the conductive tape 17 is thinner than the part where the polarization plate 18a does not overlap with the conductive tape 17 substantially by the thickness of the conductive tape 17. Provided that the thickness 11t of the CF glass substrate 11 in the part where the polarization plate 18a does not overlap with the conductive tape 17 is “a”, the thickness 11t′ of the CF glass substrate 11 in the part where the polarization plate 18a overlaps with the conductive tape 17 is “b”, and the thickness 17t of the conductive tape 17 is “c”, “a−b≈c” applies.

As shown in FIG. 7, one end 17a side of the conductive tape 17 is in a structure which is fixed by overlapping and laminating the polarization plate 18a. The thickness 11t′ of the CF glass substrate 11 in the part where the polarization plate 18a overlaps with the conductive tape 17 is thinner by the thickness 17t of the conductive tape 17t. For thinning a part of the CF glass substrate 11, the CF glass substrate 11 may be etched partially by a hydrofluoric acid solution or the like, for example. After etching a part of the CF glass substrate 11, the ITO layer 14 is provided on the surface thereof.

In the sixth exemplary embodiment, the thickness 11t′ of the CF glass substrate 11 in the part where the conductive tape 17 overlaps with the polarization plate 18a is thin by the thickness 17t of the conductive tape 17. Thus, there is no rise part generated by the thickness 17t of the conductive tape 17 in the part where the conductive tape 17 overlaps with the polarization plate 18a. Thus, with the liquid crystal display device 60, it is possible to reduce the thickness of the device. Further, the surface of the polarization plate 18a has no local rise part and can be formed flat, so that the outward appearance can be improved. Other structures, operations, and effects of the sixth exemplary embodiment are the same as those of the first exemplary embodiment.

### Seventh Exemplary Embodiment

In the first to sixth exemplary embodiments, described is the structure where the transparent conductive layer of the first substrate is grounded in the lateral electric field type liquid crystal display device. However, the present invention can be applied also to other liquid crystal display devices in which the transparent conductive layer of the first substrate needs to be grounded or connected to a circuit. For example, the present invention can be applied to an on-cell touch panel liquid crystal display device having a touch panel function mounted to the display surface of the liquid crystal display device. A seventh exemplary embodiment is related to such on-cell touch panel liquid crystal display device.

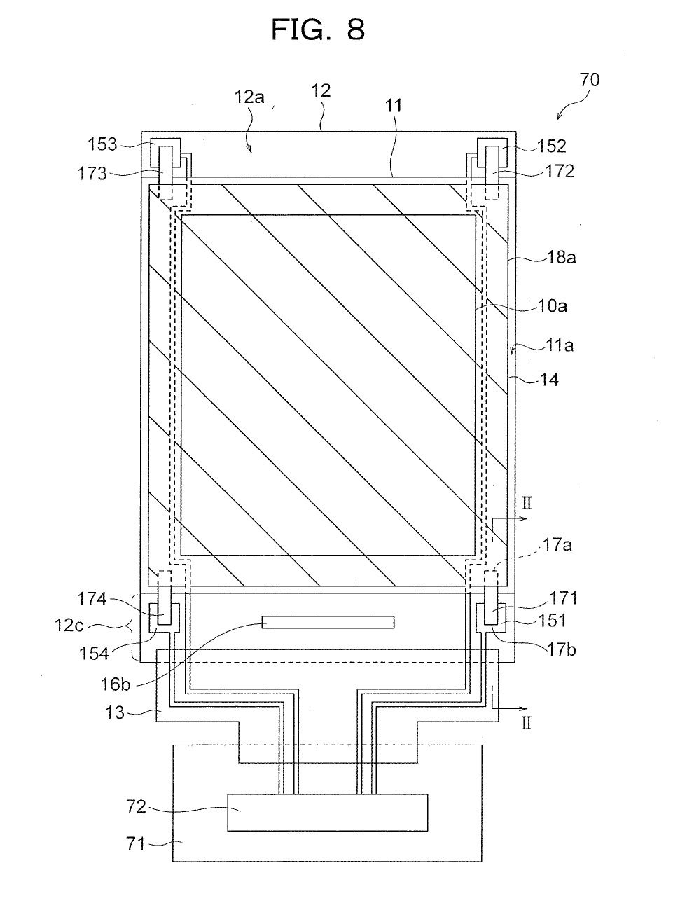

FIG. 8 is a plan view showing the liquid crystal display device of the seventh exemplary embodiment. The sectional view taken along line II-II of FIG. 8 is almost same as FIG. 2. “Conductor pattern 15” and “conductive tape 17” in FIG. 2 correspond to “conductor pattern 151” and “conductive tape 171” of the seventh exemplary embodiment, respectively. Hereinafter, explanations will be provided by referring to FIG. 8 and FIG. 2.

The liquid crystal display device 70 of the seventh exemplary embodiment includes: the CF glass substrate 11 which includes a first face 11a and a second face 11b in a front and back relation and includes a rectangular-shaped ITO layer 14 provided on the first face 11a; the TFT glass substrate 12 which includes a first face 12a and a second face 12b in a front and back relation and includes the four wiring conductor patterns 151 to 154 provided on the first face 12a; a liquid crystal material 16 interposed between the second face 11b of the CF glass substrate 11 and the first face 12a of the TFT glass substrate 12; conductive tapes 171 to 174 which connect the four corners of the ITO layer 14 and four conductor patterns 151 to 154, respectively, on one-on-one basis; the polarization plate 18a which is laminated to the first face 11a of the CF glass substrate 11 by sandwiching the ITO layer 14 therebetween; and the polarization plate 18b which is laminated to the second face 12b of the TFT glass substrate 12. Further, the conductive tapes 171 to 174 are fixed to the CF glass substrate 11 and connected to the ITO layer 14 by being sandwiched between the CF glass substrate 11 and the polarization plate 18a.

Further, the liquid crystal display device 70 includes: the adhesive layer 19a which laminates the polarization plate 18a to the CF glass substrate 11; the adhesive layer 19b which laminates the polarization plate 18b to the TFT glass substrate 12; the FPC substrate 13 connected to the first face 12a of the TFT glass substrate 12; the seal member 16a which seals the liquid crystal material 16 between the CF glass substrate 11 and the TFT glass substrate 12; a circuit substrate 71 which is connected to the FPC substrate 13; a touch panel driving IC 72 which is mounted to a circuit substrate 71 and connected to the conductor patterns 151 to 154; and the like. The inner side of the polarization plate 18a is a display area 10a.

Next, the liquid crystal display device 70 of the seventh exemplary embodiment will be described in more details.

As shown in FIG. 8 and FIG. 2, in the liquid crystal display device 70, the ITO layer 14 is provided on the surface of the CF glass substrate 11 as in the case of the lateral electric field type liquid crystal display device. The difference with respect to the case of the lateral electric field type liquid crystal display device is that same-phase and same-amplitude pulse voltages are inputted to the four corners of the ITO layer 14. The conductive tapes 171 to 174 are laminated to the four corners of the ITO layer 14, respectively. The conductive tapes 171 to 174 are connected, respectively, to the wiring conductor patterns 151 to 154 which are formed on the TFT glass substrate 12. Each of the conductor patterns 151 to 154 is connected to the touch panel driving IC 72 on the circuit substrate 71 via the FPC substrate 13.

As in the cases of the other exemplary embodiments, the seventh exemplary embodiment employs the structure in which the conductive tapes 171 to 174 are overlapped with the polarization plate 18a. The structure shown in the sectional view taken along the line II-II of FIG. 8 is the same as the structure shown in FIG. 2. Further, the on-cell touch panel liquid crystal display device 70 of the seventh exemplary embodiment can also employ the similar structures as the liquid crystal display devices of the first to sixth exemplary embodiments described above. Note that at least one of the conductive tapes 171 to 174 may be overlapped with the polarization plate 18a.

Next, actions of the liquid crystal display device 70 will be described.

First, the touch panel driving IC 72 outputs the same-phase and same-amplification pulse voltages to the conductive tapes 171 to 174 at the four corners through the conductor patterns 151 to 154. Even when the pulse voltages are applied to the ITO layer 14 from the conductive tapes 171 to 174 at the four corners, normally no electric current is flown since those voltages are of same phase and same amplification. It is because there is no potential difference generated between the conductive tapes 171 to 174.

In that state, when the display area 10a is touched by a finger or the like, a floating capacitance for GND is generated. Thus, electric currents are flown to the conductive tapes 171 to 174 at the four corners. The touch panel driving IC 72 detects the electric current values at the four corners, and calculates and outputs the position coordinates from those values. Thereby, the liquid crystal display device 70 functions as a touch panel.

Next, effects of the liquid crystal display device 70 will be described.

With the seventh exemplary embodiment, through connecting the conductive tapes 171 to 174 and the ITO layer 14 by sandwiching the conductive tapes 171 to 174 between the CF glass substrate where the ITO layer 14 is provided and the polarization plate 18a, connecting strength of the conductive tapes 171 to 174 can be improved without disturbing reduction in the thickness and the size and without disturbing light transmittance.

The conductive tapes 171 to 174 are reinforced since the polarization plate 18a is overlapped and laminated to the conductive tapes 171 to 174 on the CF glass substrate, so that exfoliation of the conductive tapes 171 to 174 by external force and heat is not easily generated.

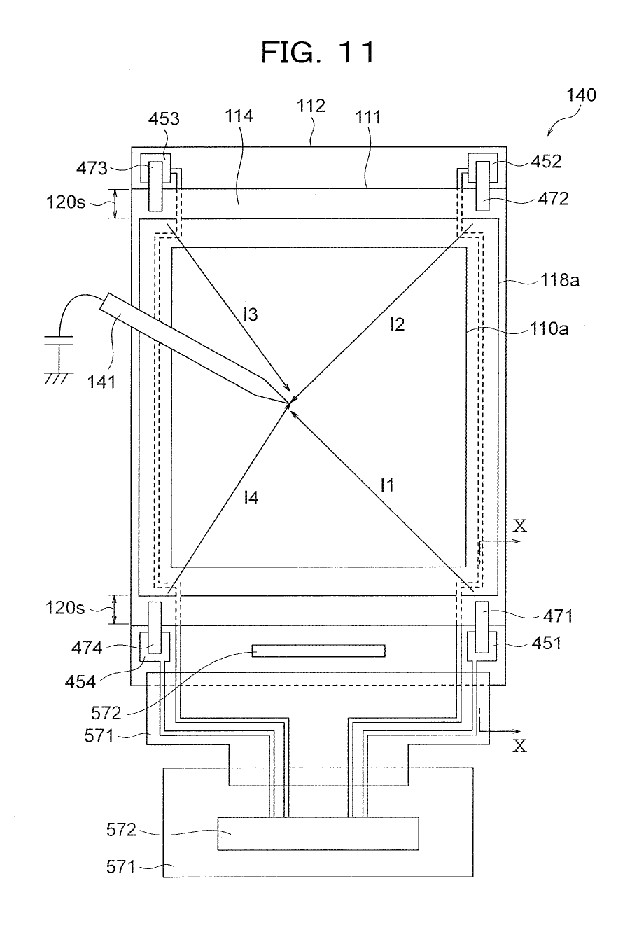

In the on-cell touch panel liquid crystal display device of Related Technique 4 shown in FIG. 11, the conductive tape is laminated on the outer side of the end part of the polarization plate so that it is necessary to provide a laminating space, which results in increasing the outmost shape size of the liquid crystal display device. On the contrary, with the seventh exemplary embodiment, the polarization plate 18a and the conductive tapes 171 to 174 are laminated in an overlapping manner. Thus, the outermost shape size can be reduced, so that reduction in the size of the liquid crystal display device 70 is not obstructed.

The polarization plate 18a is used to press the conductive tapes 171 to 174, so that no exclusive member for reinforcing the conductive tapes 171 to 174 is used. Thus, no extra cost is required.

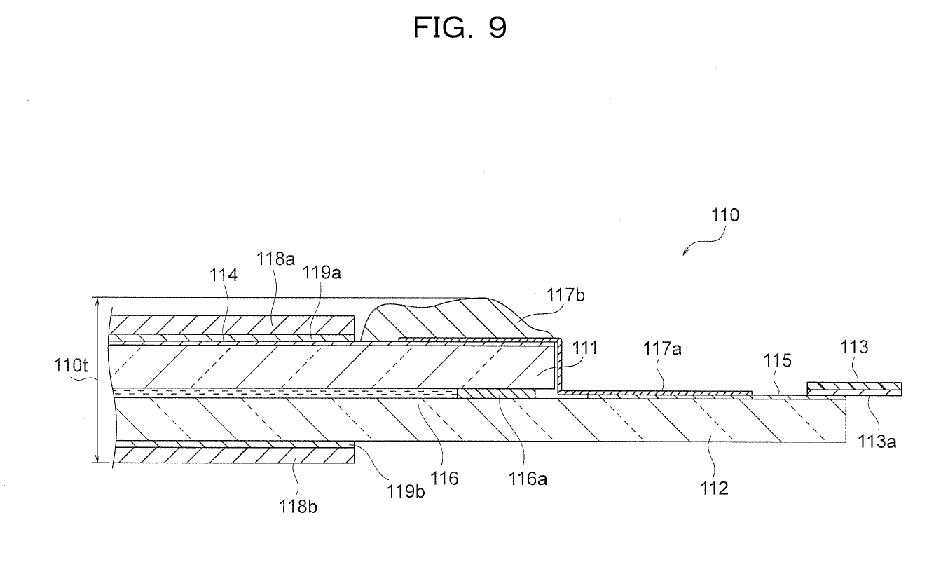

In a case where connection between the ITO layer and the conductive tape is reinforced by using a resin or the like as in Related Technique 1 shown in FIG. 9, variation in the heap of the resin is large. Thus, variation in the total thickness of the liquid crystal display device is also large. In the meantime, with the seventh exemplary embodiment, it is not necessary to reinforce connection between the ITO layer 14 and the conductive tapes 171 to 174 by using a resin or the like. Therefore, there is no such issue to be raised.

Other structures, operations, and effects of the seventh exemplary embodiment are same as those of the first to sixth exemplary embodiments.

While the present invention has been described above by referring to each of the exemplary embodiments, the present invention is not limited only to the structures and the actions of each of the exemplary embodiments described above. It is to be noted that the present invention includes various changes and modifications which can occur to those skilled in the art without departing from the scope of the present invention. Further, the present invention includes the structures acquired by mutually and properly combining a part of or a whole part of the structures of each of the above-described exemplary embodiments.

The features of the present invention will be described. Problem: To increase the connecting reliability such as the connecting strength, heat resistance, and the like when the anti-electrification transparent conductive layer (electrode layer) of the IPS type panel and the transparent conductive layer of the on-cell touch panel are grounded or connected. Structure: One end of the conductive tape is laminated to the transparent conductive layer, and the polarization plate is overlapped thereon and laminated. Effect: The grounding or connecting reliability of the transparent conductive layer is improved without deteriorating the transmittance and the image quality.

The background of the present invention will be described. As a related technique for grounding the anti-electrification transparent conductive layer (ITO layer) of the IPS type panel, there is a structure with which the ITO layer and the grounding pattern on the TFT substrate side are connected by a conductor such as a conductive tape and grounded to GND via FPC. However, conductivity of the conductive tape is secured by mixing conductive particles or the like into an adhesive, so that the adhesive force is weaker than that of a normal adhesive tape. Further, due to the narrowed frames of the panels, the pasting area of the conductive tape cannot be secured wide. Therefore, the conductive tape is easily exfoliated by an external force, heat, or the like.

The exemplary object of the present invention is to increase the connecting reliability such as the connecting strength, heat resistance, and the like when the anti-electrification transparent conductive layer of the IPS type panel and the transparent conductive layer of the on-cell touch panel are grounded or connected without increasing the outward size of the panel.

A means for solving the problem is to laminate the conductive tape for grounding or connecting to the transparent conductive layer on the color filter substrate in the part outside the display area, and to laminate the polarization plate thereon in such a manner that the conductive tape and a part of the polarization plate overlap with each other.

Effects of the present invention will be described. Electrification of the panel caused by static electricity from outside can be prevented. The polarization plate is overlapped and laminated on the conductive tape provided on the CF glass substrate, so that exfoliation due to an external force and heat is not easily generated. No extra additional member is used for reinforcing the conductive tape, so that there is no increase in the cost. When connection between the ITO layer and the conductive tape is reinforced by using a resin or the like, variation in the rise of the resin is great so that variation in the total thickness of the panel becomes also great. However, it is possible with the present invention to achieve reinforcement while keeping variation to be small. Heat or pressure is not applied for reinforcing the connection of the conductive tape, so that there is no change in the quality of the polarization plate and the panel and no deterioration in the display quality. Since the conductive tape is connected to the ITO layer on the outside of the display area, the transmittance of the panel is not deteriorated.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

While a part of or a whole part of the above-described embodiments can be summarized as following Supplementary Notes, the present invention is not limited only to the following structures.

### (Supplementary Note 1)

A conductive tape attaching structure of a liquid crystal display device which includes:

a substrate where a transparent conductive layer is provided;

a polarization plate laminated to the substrate by sandwiching the transparent conductive layer; and

a conductive tape having one end which is sandwiched between the substrate and the polarization plate and connected to the transparent conductive layer.

### (Supplementary Note 2)

A liquid crystal display device which includes:

a first substrate which includes a first face and a second face in a front and back relation, and includes an anti-electrification transparent conductive layer provided on the first face;

a second substrate which includes a first face and a second face in a front and back relation, and includes a grounding conductor pattern provided on the first face;

a liquid crystal material sealed between the second face of the first substrate and the first face of the second substrate;

a conductive tape which connects the transparent conductive layer and the conductor pattern;

a first polarization plate which is laminated to the first face of the first substrate by sandwiching the transparent conductive layer; and

a second polarization plate which is laminated to the second face of the second substrate, wherein

the conductive tape is fixed to the first substrate and connected to the transparent conductive layer by being sandwiched between the first substrate and the first polarization plate.

### (Supplementary Note 3)

A liquid crystal display device which includes:

a first substrate which includes a first face and a second face in a in a front and back relation, and includes a rectangular-shape transparent conductive layer provided on the first face;

a second substrate which includes a first face and a second face in a front and back relation, and includes four wiring conductor patterns provided on the first face;

a liquid crystal material sealed between the second face of the first substrate and the first face of the second substrate;

conductive tapes which connect four corners of the transparent conductive layer and the four conductor patterns on one-on-one basis;

a first polarization plate which is laminated to the first face of the first substrate by sandwiching the transparent conductive layer; and

a second polarization plate which is laminated to the second face of the second substrate, wherein

each of the conductive tapes is fixed to the first substrate and connected to the transparent conductive layer by being sandwiched between the first substrate and the first polarization plate.

### (Supplementary Note 4)

The liquid crystal display device as depicted in Supplementary Note 2 or 3, wherein

the conductive tape is fixed to the second substrate, and is connected to the conductor pattern by a conductive adhesive contained in the conductive tape.

### (Supplementary Note 5)

The liquid crystal display device as depicted in Supplementary Note 2 or 3, which further includes a third substrate which includes the conductor pattern and is provided on the second substrate, wherein

the conductive tape is fixed to the third substrate, and is connected to the conductor pattern by a conductive adhesive contained in the conductive tape.

### (Supplementary Note 6)

The liquid crystal display device as depicted in any one of Supplementary Notes 2 to 5, which further includes an adhesive layer for laminating the first polarization plate to the first substrate, wherein

thickness of the conductive tape is thinner than thickness of the adhesive layer.

### (Supplementary Note 7)

The liquid crystal display device as depicted in any one of Supplementary Notes 2 to 5, wherein

regarding thickness of the first polarization plate, a part where the first polarization plate overlaps with the conductive tape is thinner than a part where the first polarization plate does not overlap with the conductive tape substantially by thickness of the conductive tape.

### (Supplementary Note 8)

The liquid crystal display device as depicted in any one of Supplementary Notes 2 to 5, which further includes an adhesive layer for laminating the first polarization plate to the first substrate, wherein

regarding thickness of the adhesive layer, a part where the first polarization plate overlaps with the conductive tape is thinner than a part where the first polarization plate does not overlap with the conductive tape substantially by thickness of the conductive tape.

### (Supplementary Note 9)

The liquid crystal display device as depicted in any one of Supplementary Notes 2 to 5, wherein

regarding thickness of the first substrate, a part where the first polarization plate overlaps with the conductive tape is thinner than a part where the first polarization plate does not overlap with the conductive tape substantially by thickness of the conductive tape.

### (Supplementary Note 10)

A manufacturing method of a conductive tape attaching structure of a liquid crystal display device which includes:

a substrate where a transparent conductive layer is provided;

a polarization plate laminated to the substrate by sandwiching the transparent conductive layer; and

a conductive tape having one end which is sandwiched between the substrate and the polarization plate and connected to the transparent conductive layer, and the method includes:

overlapping the conductive tape with the transparent conductive layer, and laminating the polarization plate thereon to connect the conductive tape to the transparent conductive layer

### (Supplementary Note 11)

A manufacturing method of a liquid crystal display device which includes:

a first substrate which includes a first face and a second face in a front and back relation, and includes an anti-electrification transparent conductive layer provided on the first face;

a second substrate which includes a first face and a second face in a front and back relation, and includes a grounding conductor pattern provided on the first face;

a liquid crystal material sealed between the second face of the first substrate and the first face of the second substrate;

a conductive tape which connects the transparent conductive layer and the conductor pattern;

a first polarization plate which is laminated to the first face of the first substrate by sandwiching the transparent conductive layer; and

a second polarization plate which is laminated to the second face of the second substrate, and the method includes:

overlapping the conductive tape with the transparent conductive layer, and laminating the first polarization plate thereon to fix the conductive tape to the first substrate and connect to the transparent conductive layer.

### (Supplementary Note 12)

A manufacturing method of a liquid crystal display device which includes:

a first substrate which includes a first face and a second face in a in a front and back relation, and includes a rectangular-shape transparent conductive layer provided on the first face;

a second substrate which includes a first face and a second face in a front and back relation, and includes four wiring conductor patterns provided on the first face;

a liquid crystal material sealed between the first substrate and the second substrate;

conductive tapes which connect four corners of the transparent conductive layer and the four conductor patterns on one-on-one basis;

a first polarization plate which is laminated to the first face of the first substrate by sandwiching the transparent conductive layer; and

a second polarization plate which is laminated to the second face of the second substrate, and the method includes:

overlapping the conductive tape with the transparent conductive layer, and laminating the polarization plate thereon to fix the conductive tape to the first substrate and connect to the transparent conductive layer.

### (Supplementary Note 21)

A liquid crystal display device which includes:

a display surface side first substrate where an anti-electrification transparent conductive layer is provided; a second substrate including a grounding pattern provided in an input terminal section; a liquid crystal material which is sealed between the first substrate and the second substrate; an input substrate which is connected to the second substrate and inputs a signal to be supplied to the second substrate; a conductive tape which connects the anti-electrification transparent conductive layer and the grounding pattern; and a polarization plate which is laminated to the first substrate and an outside face of the second substrate, wherein

the conductive tape is laminated to the anti-electrification transparent conductive layer on the outer side of a display area of the first substrate, and a part of the polarization plate is laminated over the conductive tape.

### (Supplementary Note 22)

The liquid crystal display device as depicted in Supplementary Note 21, wherein

the conductive tape and the grounding pattern are connected by a conductive adhesive of the conductive tape, and a resin is applied over the conductive tape.

### (Supplementary Note 23)

The liquid crystal display device as depicted in Supplementary Note 21, wherein

the conductive tape and the grounding pattern are connected by a conductive adhesive of the conductive tape, and the conductive tape is soldered to the grounding pattern provided on the input substrate.

### (Supplementary Note 24)

The liquid crystal display device as depicted in any one of Supplementary Notes 21 to 23, wherein the conductive tape is thinner than an adhesive layer of the polarization plate on the first substrate.

### (Supplementary Note 25)

The liquid crystal display device as depicted in any one of Supplementary Notes 21 to 23, wherein

the thickness of the polarization plate in a part where the polarization plate overlaps with the conductive tape is thinner than a part where the polarization plate does not overlap with the conductive tape substantially by the thickness of the conductive tape.

### (Supplementary Note 26)

The liquid crystal display device as depicted in any one of Supplementary Notes 21 to 23, wherein

the thickness of the adhesive layer of the polarization plate in a part where the polarization plate overlaps with the conductive tape is thinner than a part where the polarization plate does not overlap with the conductive tape substantially by the thickness of the conductive tape.

### (Supplementary Note 27)

The liquid crystal display device as depicted in any one of Supplementary Notes 21 to 23, wherein

the thickness of the first substrate in a part where the polarization plate overlaps with the conductive tape is thinner than a part where the polarization plate does not overlap with the conductive tape substantially by the thickness of the conductive tape.

### (Supplementary Note 28)

An on-cell touch panel liquid crystal display device which includes:

a display surface side first substrate where an anti-electrification transparent conductive layer is provided; a second substrate including a wiring pattern provided in an input terminal section; a liquid crystal material which is sealed between the first substrate and the second substrate; an input substrate which is connected to the second substrate and inputs a signal to be supplied to the second substrate; four conductive tapes which connect four corners of the transparent conductive layer and the wiring pattern; and a polarization plate which is laminated to the first substrate and an outside face of the second substrate, wherein

the conductive tape is laminated to the anti-electrification transparent conductive layer on the outer side of a display area of the first substrate, and a part of the polarization plate is laminated over the conductive tape.

### (Supplementary Note 29)

The on-cell touch panel liquid crystal display device as depicted in Supplementary Note 28, wherein

the conductive tape and the wiring pattern are connected by a conductive adhesive of the conductive tape, and a resin is applied over the conductive tape.

### (Supplementary Note 30)

The on-cell touch panel liquid crystal display device as depicted in Supplementary Note 28, wherein

the conductive tape and the wiring pattern are connected by a conductive adhesive of the conductive tape, and at least one of the conductive tape is soldered to the wiring pattern provided on the input substrate.

### (Supplementary Note 31)

The on-cell touch panel liquid crystal display device as depicted in any one of Supplementary Notes 28 to 30, wherein the conductive tape is thinner than an adhesive layer of the polarization plate on the first substrate.

### (Supplementary Note 32)

The on-cell touch panel liquid crystal display device as depicted in any one of Supplementary Notes 28 to 30, wherein

the thickness of the polarization plate in a part where the polarization plate overlaps with the conductive tape is thinner than a part where the polarization plate does not overlap with the conductive tape substantially by the thickness of the conductive tape.

### (Supplementary Note 33)

The on-cell touch panel liquid crystal display device as depicted in any one of Supplementary Notes 28 to 30, wherein

the thickness of the adhesive layer of the polarization plate in a part where the polarization plate overlaps with the conductive tape is thinner than a part where the polarization plate does not overlap with the conductive tape substantially by the thickness of the conductive tape.

### (Supplementary Note 34)

The on-cell touch panel liquid crystal display device as depicted in any one of Supplementary Notes 28 to 30, wherein

the thickness of the first substrate in a part where the polarization plate overlaps with the conductive tape is thinner than a part where the polarization plate does not overlap with the conductive tape substantially by the thickness of the conductive tape.

### INDUSTRIAL APPLICABILITY

The present invention can be utilized to any types of liquid crystal display devices which include a substrate on which a transparent conductive layer is provided and a polarization plate laminated to the substrate by sandwiching a transparent conductive layer therebetween. Examples of such liquid crystal display devices are a lateral electric field type liquid crystal display device, an om-cell touch sensor liquid crystal display device, and the like.

What is claimed is:

1. A conductive tape attaching structure of a liquid crystal display device, comprising:
a substrate where a transparent conductive layer is provided;
a polarization plate laminated to the substrate by sandwiching the transparent conductive layer; and
a conductive tape having one end which is sandwiched between the substrate and the polarization plate and connected to the transparent conductive layer.

2. A liquid crystal display device, comprising:
a first substrate which includes a first face and a second face in a front and back relation, and includes an anti-electrification transparent conductive layer provided on the first face;
a second substrate which includes a first face and a second face in a front and back relation, and includes a grounding conductor pattern provided on the first face;
a liquid crystal material sealed between the second face of the first substrate and the first face of the second substrate;
a conductive tape which connects the transparent conductive layer and the conductor pattern;
a first polarization plate which is laminated to the first face of the first substrate by sandwiching the transparent conductive layer; and
a second polarization plate which is laminated to the second face of the second substrate, wherein
one end of the conductive tape is sandwiched between the first substrate and the first polarization plate and connected to the transparent conductive layer.

3. A liquid crystal display device, comprising:
a first substrate which includes a first face and a second face in a in a front and back relation, and includes a rectangular-shape transparent conductive layer provided on the first face;
a second substrate which includes a first face and a second face in a front and back relation, and includes four wiring conductor patterns provided on the first face;
a liquid crystal material sealed between the second face of the first substrate and the first face of the second substrate;
conductive tapes which connect four corners of the transparent conductive layer and the four conductor patterns on one-on-one basis;
a first polarization plate which is laminated to the first face of the first substrate by sandwiching the transparent conductive layer; and
a second polarization plate which is laminated to the second face of the second substrate, wherein
one end of each of the conductive tapes is sandwiched between the first substrate and the first polarization plate and connected to the transparent conductive layer.

4. The liquid crystal display device as claimed in claim 2, wherein
the conductive tape has its other one end covered by a resin applied over the conductive tape on the second substrate, and is connected to the conductor pattern by a conductive adhesive contained in the conductive tape.

5. The liquid crystal display device as claimed in claim 3, wherein
the conductive tape has its other one end covered by a resin applied over the conductive tape on the second substrate, and is connected to the conductor pattern by a conductive adhesive contained in the conductive tape.

6. The liquid crystal display device as claimed in claim 2, further comprising a third substrate which includes the conductor pattern and is provided on the second substrate, wherein
the conductive tape has its other one end fixed by a solder to the third substrate, and is connected to the conductor pattern by a conductive adhesive contained in the conductive tape.

7. The liquid crystal display device as claimed in claim 3, further comprising a third substrate which includes the conductor pattern and is provided on the second substrate, wherein
the conductive tape has its other one end fixed by a solder to the third substrate, and is connected to the conductor pattern by a conductive adhesive contained in the conductive tape.

8. The liquid crystal display device as claimed in claim 2, wherein
regarding thickness of the first polarization plate, a part where the first polarization plate overlaps with the conductive tape is thinner than a part where the first polarization plate does not overlap with the conductive tape substantially by thickness of the conductive tape.

9. The liquid crystal display device as claimed in claim 3, wherein
regarding thickness of the first polarization plate, a part where the first polarization plate overlaps with the conductive tape is thinner than a part where the first polarization plate does not overlap with the conductive tape substantially by thickness of the conductive tape.

10. The liquid crystal display device as claimed in claim 2, further comprising an adhesive layer for laminating the first polarization plate to the first substrate, wherein
thickness of the conductive tape is thinner than thickness of the adhesive layer.

11. The liquid crystal display device as claimed in claim 3, further comprising an adhesive layer for laminating the first polarization plate to the first substrate, wherein thickness of the conductive tape is thinner than thickness of the adhesive layer.

12. The liquid crystal display device as claimed in claim 2, further comprising an adhesive layer for laminating the first polarization plate to the first substrate, wherein
regarding thickness of the adhesive layer, a part where the first polarization plate overlaps with the conductive tape is thinner than a part where the first polarization plate does not overlap with the conductive tape substantially by thickness of the conductive tape.

13. The liquid crystal display device as claimed in claim 3, further comprising an adhesive layer for laminating the first polarization plate to the first substrate, wherein
regarding thickness of the adhesive layer, a part where the first polarization plate overlaps with the conductive tape is thinner than a part where the first polarization plate does not overlap with the conductive tape substantially by thickness of the conductive tape.

14. The liquid crystal display device as claimed in claim 2, wherein
regarding thickness of the first substrate, a part where the first polarization plate overlaps with the conductive tape is thinner than a part where the first polarization plate does not overlap with the conductive tape substantially by thickness of the conductive tape.

15. The liquid crystal display device as claimed in claim 3, wherein
regarding thickness of the first substrate, a part where the first polarization plate overlaps with the conductive tape is thinner than a part where the first polarization plate does not overlap with the conductive tape substantially by thickness of the conductive tape.
